(19) United States
(12) Patent Application Publication
(10) Pub. No.: US 2026/0198465 A1
(43) Pub. Date: Jul. 16, 2026

(54) FISH FARMING ENCLOSURE

(71) Applicant: Alfa Laval Corporate AB, LUND (SE)

(72) Inventors: Thomas STØRKSON, BØNES (NO); Oddbjørn JACOBSEN, HORDVIK (NO); Terje LJONES, NORHEIMSUND (NO); Milan MILOVANOVIC, FLORVÅG (NO); Håkon HYSTAD, FLORVÅG (NO); Henrik MARKHUS, BERGEN (NO); Olav Are FRØYNES, LOFTHUS (NO); Caroline GJERTSEN, BERGEN (NO)

(73) Assignee: Alfa Laval Corporate AB, LUND (SE)

(21) Appl. No.: 19/133,340

(22) PCT Filed: Nov. 30, 2023
(86) PCT No.: PCT/EP2023/083796

§ 371 Date: May 28, 2025

(30) Foreign Application Priority Data
Nov. 30, 2022 (NO) 20221285

(51) Int. Cl. A01K 63/04; A01K 61/10

(52) U.S. Cl. CPC A01K 63/04; A01K 61/10

(57) ABSTRACT

The disclosure concerns a fish farming enclosure. The enclosure defines an internal volume and comprises a bottom, a side wall arrangement, a water inlet arrangement for admitting water into the internal volume arranged at the side wall arrangement, and a water outlet arrangement for outflow of water from the internal volume arranged centrally of the side wall arrangement. The water outlet arrangement comprises an elongated conduit member. A sludge collecting member extends along a radial direction beyond the elongated conduit member. The sludge collecting member is provided with a through opening such that a water passage is formed through the sludge collecting member. The water passage forms part of the water outlet arrangement.

### TECHNICAL FIELD

The invention relates to a fish farming enclosure.

### BACKGROUND

In fish farming, good water quality is one concern. Inter alia exchange of the water within a fish farming enclosure and removal of sludge within the fish farming enclosure are factors that influence the quality of the water within the fish farming enclosure.

WO 2020/126988 discloses a fish farming tank for cultivating living fish. The tank comprises an active flow control system for generating a circulating flow of water within the tank. The active flow control system has a first water inlet arrangement for injecting water into the internal volume and a first water outlet arrangement for removing water from the internal volume. The first water inlet arrangement is configured for injecting water over more than half of a maximal depth stretching from an interior surface of the bottom to the maximal water fill level. A water outlet region of the water outlet arrangement extends in a vertical direction over more than 50%, or 65 %, or 80% of the maximal depth. Thus, the water inlet and outlet arrangements cooperate to provide a flow of water within the entire tank. Regions with stagnant water are thus, avoided in the tank.

US 2020/396966 discloses a so-called mort (dead fish) trap assembly that includes an upper ramp and lower ramp. The mort trap assembly relies on a slide to ensure that dead fish are transported by gravity into the mort trap. A retaining chamber is located below the upper ramp and in connection with the lower ramp. A purge pipe for mort is fluidly connected to the retaining chamber. The mort trap is arranged at a lower end of an enclosure. The enclosure is in the form of a netting assembly. In such an enclosure, sludge and debris smaller than a mesh size of the netting falls through the bottom of the netting assembly. Thus, the mort trap assembly is devised to handle only the removal of dead fish. Removal of sludge with the mort trap is neither necessary nor envisaged.

### SUMMARY

Conditions for ensuring good water quality within a fish farming tank are provided in a fish farming tank of the kind disclosed in WO 2020/126988. However, despite the circular flow provided in the fish farming tank, it has been discovered that not all sludge is transported with the water flow out of the tank via the water outlet arrangement. Accordingly, there is room for further improvement of the water quality.

It would be advantageous to achieve a fish farming enclosure overcoming, or at least alleviating, water quality problems related to sludge. In particular, it would be desirable to enable removal of sludge from a fish farming enclosure having a centrally arranged water outlet arrangement. To better address one or more of these concerns, a fish farming enclosure having the features defined in the independent claim is provided.

According to an aspect of the invention, the object is achieved by a fish farming enclosure for cultivating living fish. The fish farming enclosure defines an internal volume for holding water up to a maximum water fill level and comprises a bottom, a side wall arrangement, a water inlet arrangement for admitting water into the internal volume arranged at the side wall arrangement, and a water outlet arrangement for outflow of water from the internal volume arranged centrally of the side wall arrangement. The water inlet arrangement is configured for admitting water into the internal volume substantially along an entire distance between the maximum water fill level and a level of the bottom in a region of the water inlet arrangement. The water outlet arrangement comprises an elongated conduit member extending along a longitudinal direction from a first end portion of the elongated conduit member to a second end portion thereof, the first end portion being arranged within a region of the maximum water fill level and the second end portion being arranged at a level of a centre region of the bottom. The fish farming enclosure comprises a sludge collecting member arranged at the second end portion of the elongated conduit member, wherein the sludge collecting member extends along a radial direction, perpendicularly to the longitudinal direction, beyond the radial direction of the elongated conduit member, wherein the sludge collecting member is provided with a through opening such that a water passage is formed through the sludge collecting member, and wherein the water passage forms part of the water outlet arrangement.

The elongated conduit member may either continue through the through opening in the sludge collecting member or be connected to the sludge collecting member in such a way that a closed passage from the elongated conduit member to the water passage of the sludge collecting member is created. In this way all the water flowing through the water outlet arrangement will flow through the water passage of the sludge member, and to below the bottom of the enclosure, without interfering with any sludge collected in the radial direction of the sludge collecting member.

As the water inlet is arranged at the side wall arrangement and the water outlet is arranged centrally of the side wall arrangement, a water flow towards the centre of the enclosure will be created. Further, since the above defined fish farming enclosure comprises a sludge collecting member arranged at the second end portion of the elongated conduit member, since the sludge collecting member extends along a radial direction, perpendicularly to the longitudinal direction, beyond the radial direction of the elongated conduit member, since the sludge collecting member is provided with a through opening such that a water passage is formed through the sludge collecting member, and since the water passage forms part of the water outlet arrangement—sludge and other matter from the internal volume of the fish farming enclosure will be moving towards the centre of the enclosure, and collected in the sludge collecting member. Further, since the water is flowing through the sludge collecting member in a closed passage, the sludge and other matter will be collected in the collection member and prevented from mixing with the water in the internal volume. Accordingly, the fish farming enclosure is configured for providing good water quality therein and thus, good water conditions for fish farming.

The fish farming enclosure may be a pen or a cage suspended in open water. At least portions of the enclosure may be made of canvas or other sheet-like materials which are water impermeable, or at least have a limited water permeability. The fish farming enclosure may further be made of stiff/hard materials such as steel, plastic, concrete or fiberglass or even a combination of stiff/hard materials and bendable materials such as canvas.

Alternatively, the fish farming enclosure may comprise a tank with a solid bottom and a solid side wall arrangement. The tank may be placed on land, indoors or outdoors.

For instance, a bottom made from canvas and/or other sheet-like materials may be utilised in order to prevent sludge, debris, dead fish, and/or similar matter sinking to the bottom of the fish farming enclosure to spread into ambient open water. In a land-based fish farming enclosure, sludge, debris, dead fish, and/or similar matter will end up on the solid bottom of the enclosure.

Herein, the fish farming enclosure alternatively, may be referred to simply as, the enclosure. Herein, positions and directions, such as upper, lower, above, below, horizontal, and vertical relate to the fish farming enclosure and relevant features thereof, when it is arranged for practical use and filled with water up approximately the maximum water fill level.

Herein, a longitudinal direction of the elongated conduit member is defined. In use of the fish farming enclosure, the longitudinal direction extends substantially vertically. The radial direction mentioned herein extends perpendicularly to the longitudinal direction. Accordingly, the radial direction may extend substantially horizontally.

The internal volume of the enclosure forms a delimited space within which the fish are cultivated. The bottom and the side wall arrangement form the internal volume. The side wall arrangement may extend to above the maximum water fill level.

The side wall arrangement extends substantially vertically and may comprise one wall element e.g., forming a round or oval enclosure. Alternatively, the side wall arrangement may comprise more than one wall element connected to each other e.g., forming a multisided enclosure, such as a substantially square, hexagonal, or octagonal enclosure. The bottom connects to the side wall arrangement.

The water inlet arrangement may comprise one or more inlet members, such as tubes, extending in a substantially vertical direction and being arranged within the internal volume adjacent to the side wall arrangement.

One or more water inlet openings of the water inlet arrangement are arranged along the vertical direction. For instance, the one or more inlet openings may be arranged along the one or more inlet members. Thus, the water inlet arrangement may be configured for admitting water into the internal volume along the entire distance between the maximum water fill level and the level of the bottom, through the one or more inlet openings.

The water inlet arrangement being configured for admitting water into the internal volume substantially along an entire distance between the maximum water fill level and a level of the bottom in a region of the water inlet arrangement can be defined as substantially along an entire distance from the maximum water fill level to a connection between the wall arrangement and the bottom of the fish farming enclosure.

The water outlet arrangement being arranged centrally of the side wall arrangement means that the elongated conduit member is arranged at a midpoint of a longest diameter, or a longest diagonal, of a horizontal cross section of the enclosure. Thus, the inlet arrangement and particularly the elongated conduit member is arranged at the centre of the internal volume.

The longitudinal direction of the elongated conduit member may extend substantially vertically.

The first end portion of the elongated conduit member being arranged within a region of the maximum water fill level may mean that the first end portion is arranged in relation to the maximum water fill level within a range of 0-10% of a distance between the maximum water fill level and the level of the centre region of the bottom.

One or more water outlet openings of the water outlet arrangement are arranged along the elongated conduit member along the longitudinal direction.

The water inlet arrangement and the water outlet arrangement form an active flow control system for generating a circulating flow of water within the enclosure.

The active flow control system is configured for providing circulating flow of water within the enclosure. The circulating flow ensures good and equal water quality within the internal volume during use of the fish farming enclosure. Herein, equal water quality within the internal volume means that the water quality within the internal volume does not vary to any large extent between different portions of the internal volume.

During use of the enclosure, the circulating flow of water circulates from the water inlet arrangement at the side wall arrangement in a spiral towards the centrally arranged water outlet arrangement.

Moreover, the circulating flow of water may take the form of a vertically layered water flow within the internal volume. That is, water flows mainly within respective horizontal regions from the water inlet arrangement to the water outlet arrangement. The thus, produced water exchange in the horizontal direction within the enclosure is considerably higher than water exchange in the vertical direction.

This layered circulating flow of water in the vertical direction of the tank efficiently avoids occurrence of still standing water regions, and by having the water inlet arrangement configured for admitting water over substantially the depth of water within the enclosure, stretching from an interior surface of the bottom to the maximal water fill level.

Since the water inlet arrangement is configured for admitting water into the internal volume substantially along an entire distance between the maximum water fill level and the level of the bottom in the region of the water inlet arrangement, a substantially even flow is achieved between layers along the water depth.

One or more water moving devices may form part of the water inlet arrangement. The one or more water moving device may contribute to the admitting of water into the enclosure. The one or more water moving devices may be any kind of device/s which is/are capable of drawing water into the inlet arrangement and inject the water, through the one or more inlet openings into the water that is currently in the internal volume of the enclosure.

Additionally, or alternatively, one or more water moving devices may form part of the water outlet arrangement. These one or more water moving devices may contribute to the outflow of water from the enclosure. The one or more water moving devices may be any kind of device/s which is/are capable of drawing water from the internal volume through the one or more outlet openings into the outlet arrangement and transporting the water through the elongated conduit member to outside the internal volume.

Examples of water moving devices are pump, impeller, airlift pump, injector, etc.

Particles of dissolved feed, excrements, etc. may form constituents of sludge forming in the enclosure. Also, debris may form part of the sludge. The term debris may refer to larger identifiable separate particles e.g., larger parts of fish feed. Also, dead fish form matter that should not remain in the internal volume of the enclosure for longer periods of time than necessary.

The sludge collecting member may be devised for collecting not only sludge but also other larger matter, such as debris and dead fish.

The sludge collecting member may have any shape that forms one or more receptacles, bowls, plates, or similarly shaped structures that may be arranged in open communication with the internal volume of the enclosure and that is suitable for receiving sludge and other matter from the internal volume.

The sludge collecting member extending along the radial extension beyond the elongated conduit member, means that the sludge collecting member is devised for receiving sludge and other matter from the internal volume while also providing for the provision of the through opening in order to provide for the water passage through sludge collecting member.

The water passage may either be a passage in direct contact with water passing out from the enclosure. Alternatively, the water passage may provide for a portion of the elongated conduit member or other conduit member to extend therethrough and thus, form a passage that is not in direct contact with the water passing out from the enclosure.

The sludge collecting member may have a substantially circular outer periphery seen in a view along the longitudinal direction of the elongated conduit member. Accordingly, the sludge collecting member may have a larger diameter than the elongated conduit member.

A body of the sludge colleting member may be made from a water-impermeable material, such as a plastic material or a fibre reinforced plastic material. Thus, sludge and other matter may be reliably collected in the sludge collecting member. At the sludge collecting member, only the through opening forming the water passage permits water to pass, directly or indirectly, through the sludge collecting member.

For instance, part of the body of the sludge collecting member may be shaped as at least one trough in which sludge and other matter is collected. The sludge and other matter may settle within the trough, for a limited time. The sludge may be transported from the trough, continuously or intermittently.

By “trough” it is herein meant a circular collector arranged around the through opening, wherein the walls may be slanting or straight towards a floor that may be flat or curved in radial direction. The trough may have an opening towards the enclosure in such a way that sludge and other matter will fall into the trough. The opening may be the full distance between the walls, opposite the floor. The slanting walls and curved floor may be giving the trough a V or U shaped axial cross section on each side of the through opening. When the walls are slanting and the floor is curved, the trough may have the shape of a donut. The trough may have straight walls and flat floor.

The floor of the collector may be slanting around the through opening towards an outlet, wherein the sludge may be removed from the collector. In this way any sludge being collected on the floor will slide circularly around the through opening until it is collected at the lowest point of the collector where the outlet may be arranged. The floor may be slanting from two or more sides towards a low point having an outlet for removing sludge. The collector may be separated in two or more parts, on different sides of the through hole, possibly divided by partition walls. The floor in each part slants towards an outlet for removing sludge.

It has been realised by the inventors, that by ensuring that the circulating water flow reaches the bottom of the enclosure, the circulating flow of water created by the active flow control will transport sludge and other matter that has sunk to the bottom of the enclosure towards a centre of the enclosure.

Thus, even in an enclosure with the bottom arranged with a limited deviation downwards from a horizontal plane, transport of sludge and other matter towards the centre of the enclosure is ensured.

Accordingly, the sludge collecting member that is arranged centrally within the enclosure at the second end portion of the elongated conduit member will collect sludge and other matter at least from a major portion of a surface of the bottom of the enclosure even in an enclosure with the bottom arranged with a limited deviation from a horizontal plane.

According to some embodiments, the bottom of the enclosure may extend downwards at an angle within a range of 0 -30 degrees to a horizontal plane, such as at an angle within a range of 0 -20 degrees to a horizontal plane.

According to some embodiments, the bottom of the enclosure may extend downwards at an angle of up to 45 degrees to a horizontal plane.

According to embodiments, the elongated conduit member may be configured for outflow of water from the internal volume substantially along an entire distance between the first end portion and the level of the centre region of the bottom. In this manner, it may be ensured that in conjunction with the water inlet arrangement being configured for admitting water into the internal volume substantially along an entire distance between the maximum water fill level and a level of the bottom in a region of the water inlet arrangement-the circulating flow of water takes the form of a vertically layered water flow within the internal volume. Thus, it may be ensured that regions of stagnant water are avoided in the internal volume.

Moreover, in this manner it may be ensured that the circulating flow reaches the bottom of the enclosure to transport sludge and other matter towards the centre region of the bottom and the sludge collecting member.

The elongated conduit member may be configured for outflow of water from the internal volume substantially along an entire distance between the first end portion and a level above the sludge collecting member, by having a number of holes in the elongated conduit member. In this way, a circulating flow of water will be ensured in the enclosure, from the inlets to the holes of the elongated member. At a level above the sludge collecting member, the elongated conduit member may not be provided with holes which will prevent any sludge and other matter being transported towards the centre region of the bottom from flowing into the outflow of water. The distance from the sludge collecting member to the level having holes for outflow of water, should be sufficient long to prevent any sludge being shuffled over the opening of the sludge collecting member and/or being whirled up as it hits a side of the elongated conduit member, to enter the holes and get into the elongated conduit member.

According to embodiments, the bottom may be impermeable to sludge. In this manner, sludge and other matter may be transported along the bottom of the enclosure towards the centre region of the bottom and the sludge collecting member.

According to embodiments, the sludge collecting member may comprise at least one trough-shaped portion for receiving sludge therein, and the at least one trough-shaped portion may be arranged below the level of the centre region of the bottom. In this manner, sludge and other matter having been transported by the water flow towards the centre region of the bottom sink downwardly into the at least one trough-shaped portion. When in the at least one trough-shaped portion, the sludge is thus removed from the water flowing within the internal volume. Accordingly, good water quality within the internal volume may be ensured.

Put differently, the circulating flow within the internal volume may not reach into the at least one trough-shaped portion arranged below the level of the centre region of the bottom. Thus, the sludge may settle within the at least one trough-shaped portion.

According to embodiments, the sludge collecting member may be provided with at least one outlet for sludge. In this manner, the sludge collecting member may be relieved of sludge via the at least one outlet for sludge.

Further features of, and advantages with, the invention will become apparent when studying the appended claims and the following detailed description.

### BRIEF DESCRIPTION OF THE DRAWINGS

Various aspects and/or embodiments of the invention, including its particular features and advantages, will be readily understood from the example embodiments discussed in the following detailed description and the accompanying drawings, in which:

FIGS. 1a and 1b schematically illustrate a fish farming enclosure according to embodiments,

FIGS. 2a-2c schematically illustrate a sludge collecting member according to embodiments,

FIGS. 3a and 3b disclose embodiments of a water outlet arrangement,

FIG. 4 schematically illustrates a cross section through a fish farming enclosure according to embodiments, and

FIGS. 5a-5c schematically illustrate embodiments of a water outlet arrangement.

### DETAILED DESCRIPTION

Aspects and/or embodiments of the invention will now be described more fully. Like numbers refer to like elements throughout. Well-known functions or constructions will not necessarily be described in detail for brevity and/or clarity.

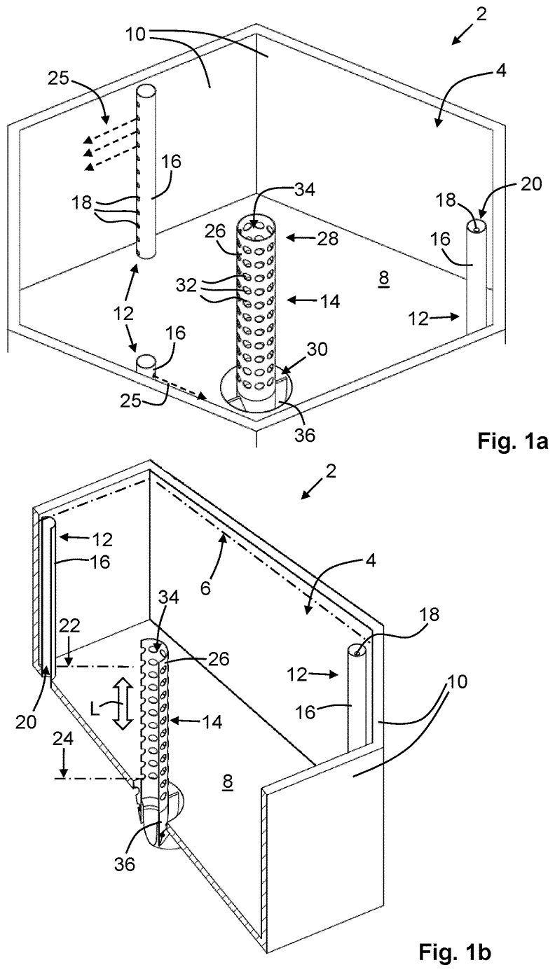

FIGS. 1a and 1b schematically illustrate a fish farming enclosure 2 according to embodiments. FIG. 1a shows a perspective view of the enclosure 2 with partially removed side walls and FIG. 1b shows a cross section through the enclosure 2 with a partially removed side wall.

The fish farming enclosure 2 is configured for cultivating living fish therein. In the illustrated embodiments, the fish farming enclosure 2 is embodied in the form of a tank to be utilised for land-based fish farming. In alternative embodiments, the fish farming enclosure may be embodied in the form of a pen or a cage suspended in open water e.g., comprising portions made of canvas or other sheet-like materials.

The enclosure 2 defines an internal volume 4 for holding water up to a maximum water fill level 6. The enclosure 2 comprises a bottom 8 and a side wall arrangement 10. The internal volume 4 is defined at least in part by the bottom 8 and the side wall arrangement 10.

In the illustrated embodiments, the side wall arrangement 10 comprises four wall elements arranged to delimit therebetween and between the bottom 8 an internal volume 4 having a square or rectangular horizontal cross section. In alternative embodiments, the internal volume may have a different horizontal cross section, such as round, oval, pentagonal, hexagonal, etc.

The maximum water fill level 6 may for example be represented by an overflow level of the enclosure 2. The overflow level may for example be defined by a specifically provided overflow outlet, which for example may be provided in the side wall arrangement 10.

Alternatively, the overflow level may for example simply be defined by the water level at which water begins to flow over an upper edge of the side wall arrangement 10. A further alternatively, may be for the maximum water fill level 6 to be represented be a specific fill level marking indicating an intended maximal water fill level.

The fish farming enclosure 2 further comprises a water inlet arrangement 12 for admitting water into the internal volume 4 and a water outlet arrangement 14 for outflow of water from the internal volume 4. The water inlet arrangement 12 is arranged at the side wall arrangement 10. The water outlet arrangement 14 is arranged centrally of the side wall arrangement 10 i.e., substantially at a centre of the internal volume 4 and the bottom 8.

The water inlet arrangement 12 and the water outlet arrangement 14 form part of an active flow control system for generating a circulating flow of water within the internal volume 4.

The water inlet arrangement 12 comprises a number of separate inlet members 16 evenly distributed along a circumference of the internal volume 4. Each inlet member 16 has a vertical direction and is arranged adjacent to the side wall arrangement 10, such as adjacent to a wall element of the side wall arrangement 10.

In the illustrated embodiments, the water inlet arrangement 12 comprises three inlet members 16. In alternative embodiments, the water inlet arrangement 12 may comprise any number of water inlet members, such as for example two, three, four, five, six, or more, depending e.g., on the size and form of the internal volume 4 and a desired flow rate within the internal volume 4.

For the sake of clarity, in FIG. 1a two of the inlet members 16 are shown in a horizontal cross section. In FIG. 1b, two inlet members 16 are shown without an upper end closing member, such as an end wall or a lid.

Each inlet member 16 may comprise a tube provided with inlet openings 18. The tube as such provides an inflow passage 20. Thus, during use of the enclosure 2 water flows through the inflow passage 20 and via the inlet openings 18 into the internal volume 4.

The water inlet arrangement 12 is configured for admitting water into the internal volume 4 substantially along an entire distance between the maximum water fill level 6 and a level 22 of the bottom 8 in a region of the water inlet arrangement 12, where the side wall arrangement is connected to the bottom. This may be achieved by a single elongated inlet opening stretching in the vertical direction or, as in the illustrated embodiments, by a number of water inlet openings 18 being arranged along the vertical direction.

A single elongated opening may for example be provided by means of the water inlet arrangement 12 being provided with an elongated slit i.e., a long narrow opening defined by two straight and parallel edges.

The term “substantially along an entire distance between the maximum water fill level 6 and a level 22 of the bottom 8 in a region of the water inlet arrangement 12” may in this context mean over at least 90 % of the distance between the maximum water fill level 6 and a level 22 of the bottom 8 in a region of the water inlet arrangement 12.

It may be noted that, depending on whether the bottom 8 slants downwards from its periphery towards its centre or not, the level 22 of the bottom 8 in the region of the water inlet arrangement 12 is above a level 24 of the bottom 8 in a centre region of the bottom 8 or at the same level as the level 24 of the bottom 8 in the centre region of the bottom 8.

According to the illustrated embodiments, the water inlet arrangement 12 is provided with inlet openings 18. The inlet openings 18 may be arranged to admit water into the internal volume 4 in a direction including a horizontal and tangential component relative to the side wall arrangement 10. In this manner, the circulating water flow of the active flow control within the internal volume may be initiated.

More specifically, the inlet members 16 of the water inlet arrangement 12 may be provided with the inlet openings 18 arranged to admit water into the internal volume 4 in a direction including a horizontal and tangential component relative to the side wall arrangement 10.

The thus, resulting inflow of water in a horizontal and tangential direction is indicated with broken line arrows 25 in FIG. 1a.

Mentioned purely as an example, a direction including a horizontal and tangential component relative to the side wall arrangement 10 may be a direction extending +/−10 degrees from a horizontal direction and +/−30 degrees from a tangent of the side wall arrangement in a region adjacent to the water inlet arrangement 12.

The water outlet arrangement 14 comprises an elongated conduit member 26. The elongated conduit member 26 extends along a longitudinal direction L, from a first end portion 28 of the elongated conduit member 26 to a second end portion 30 thereof. The first end portion 28 is arranged within a region of the maximum water fill level 6 and the second end portion 30 is arranged at the level 24 of the centre region of the bottom 8.

The elongated conduit member 26 is configured for outflow of water from the internal volume 4 substantially along an entire distance between the first end portion 28 and the level 24 of the centre region of the bottom 8, or a level above the sludge collecting member.

The term “substantially along an entire distance between the first end portion 28 and the level 24 of the centre region of the bottom 8” may in this context mean over at least 90 % of the distance between the first end portion 28 and the level 24 of the centre region of the bottom 8.

For this purpose, the elongated conduit member 26 is provided with a number of outlet openings 32 arranged along the longitudinal direction L. The outlet openings 32 are arranged to receive water flowing out of the internal volume 4, such that the water flowing out of the internal volume 4 can flow into the elongated conduit member 26, and therein downwardly out of the internal volume 4 to below the bottom 8. Accordingly, the elongated conduit member 26 forms an outflow passage 34 for the water from the internal volume 4.

The outlet openings 32 are arranged around a circumference of the elongated conduit member 26, such that water is received from more than one horizontal direction. The number of outlet openings 32 are located around substantially the entire periphery of the elongated conduit member 26.

In alternative embodiments, the elongated conduit member may be provided with one or more elongated water outlet openings, such as one or more slits, extending along substantial an entire length of the elongated conduit member.

In an alternative, not shown embodiment, the elongated conduit member 26 is provided with openings 32 substantially along an entire distance between the first end portion 28 and a level above the centre region of the bottom 8. This is to prevent that any sludge, debris or other matter collected at the bottom of the enclosure may flow through the openings and into the conduit member. In this alternative embodiment, a lower part of the elongated conduit member 26, from the connection to the sludge collecting member to the above said level, is not provided with openings, but has a water passage to transport the water into the through opening 38 of the sludge collecting member and out of the enclosure.

For the sake of clarity, in FIGS. 1a and 1b the elongated conduit member 26 is shown without an upper end closing member, such as an end wall or a lid.

The enclosure 2 comprises a sludge collecting member 36 arranged at the second end portion 30 of the elongated conduit member 26.

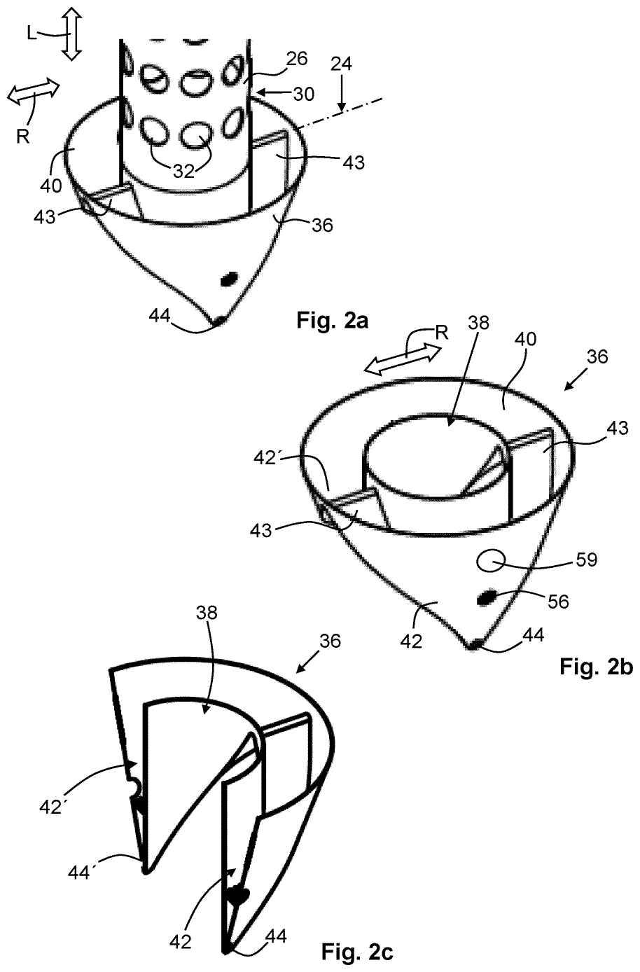

The sludge collecting member 36 is discussed in further detail with reference to FIGS. 2a-4.

FIGS. 2a-2c schematically illustrate a sludge collecting member 36 according to embodiments. FIG. 2a shows a perspective view of the sludge collecting member 36 and an elongated conduit member 26. FIG. 2b shows a perspective view of the sludge collecting member 36. FIG. 2c shows a cross section of the sludge collecting member 36.

The sludge collecting member 36 may be a sludge collecting member 36 as discussed above with reference to FIGS. 1a and 1b. Accordingly, in the following reference is also made to FIGS. 1a and 1b.

In the fish farming enclosure 2, the sludge collecting member 36 is arranged at a second end portion 30 of the elongated conduit member 26.

The sludge collecting member 36 extends along a radial direction R, perpendicularly to the longitudinal direction L. In this radial direction R, the sludge collecting member 36 extends beyond an extension of the elongated conduit member 26. Put differently, the sludge collecting member 36 has a larger diameter than the elongated conduit member 26.

The sludge collecting member 36 is provided with a through opening 38 such that a water passage is formed through the sludge collecting member 36. The water passage formed by the through opening 38 forms part of the water outlet arrangement 14, see also FIGS. 1a and 1b, and are connected to the elongated conduit member 26 in such a way that a closed water passage is created.

The sludge collecting member 36 comprises a body 40. The body 40 may be one single element. Alternatively, the body 40 may be an assembly of two or more elements.

Mentioned purely as an example, the body 40 may comprise a fibre reinforced plastic material.

A size of the sludge collecting member and its body 40 may depend on the size of the fish farming enclosure 2. Mentioned purely as an example, a radial extension R of the sludge collecting member 36 and its body 40 i.e., the diameter, may be within a range of 1.5-4 m.

The sludge collecting member 36 comprises at least one trough-shaped portion 42, 42′ for receiving sludge therein. For instance, the body 40 may form the at least one trough-shaped portion 42, 42′. The trough-shaped portions as in the illustrated embodiments, have outer slanting wall(s), and inner straight walls connected by a floor, wherein sludge receiving compartments or troughs are created between the walls and floor. The troughs are in open communication with the enclosure 2 in the longitudinal direction L.

The at least one trough-shaped portion 42, 42′ is arranged below the level 24 of the centre region of the bottom 8 of the enclosure, see also FIG. 1b. Sludge and other matter will thus, drop from the level 24 of the bottom 8 into the at least one trough-shaped portion 42, 42′. Moreover, in the at least one trough-shaped portion 42, 42′, the flow within the internal volume 4 cannot disturb settling of the sludge and other matter.

According to embodiments, such as the illustrated embodiments, the at least one trough-shaped portion 42, 42′may be arranged circumferentially with respect to the longitudinal direction L of the elongated conduit member 26. In this manner, the at least one trough-shaped portion 42, 42′may be arranged to receive sludge and other matter circumferentially around the entire elongated conduit member 26.

According to embodiments, such as the illustrated embodiments, the sludge collecting member 36 may comprise at least two trough-shaped portions 42, 42′ for receiving sludge therein. In this manner, two separate compartments for receiving sludge and other matter therein may be provided. The sludge within each trough-shaped portion 42, 42′ may settle easier towards a bottom of each trough-shaped portion 42, 42′ for removal therefrom than if the sludge collecting member 36 comprises only one trough-shaped portion 42, 42′.

For instance, at least one partition 43 wall may be arranged between the at least two trough-shaped portions 42, 42′. Thus, the at least one partition wall 43 contributes for providing separate sludge receiving compartments in the sludge collecting member 36.

For instance, the at least one partition wall 43 may be arranged at a distance from the second end portion 30 of the elongated conduit member 26, seen along the longitudinal direction L. Specifically, the at least one partition wall 43 may be arranged at a distance from a bottommost outlet opening 32 of the elongated conduit member 26. Thus, the circulating flow within the internal volume 4 may remain stable all the way to adjacent to the elongated conduit member 26, which may ensure that sludge and other matter are drawn by the circulating flow to the at least two trough-shaped portions 42, 42′.

According to the illustrated embodiments, the sludge collector has two trough-shaped portions/compartments for receiving sludge, both portions/compartments having a floor slanting circularly around the through opening 38, into a tip where at least one outlet 44 for sludge is provided. That is, the floor of each portion/compartment for receiving sludge may have two parts, one slanting clockwise and one slanting counterclockwise until they meet, so that any sludge entering the portion/compartment will slide on the floor and be collected at the tip. The above-mentioned partition wall 46 may also be a part of the floor. In this manner, sludge may be removed from the sludge collecting member 36 via the at least one outlet 44, 44′ for sludge. See further below with reference to FIG. 4.

With reference to FIG. 2b, the sludge collecting member 36 may be provided with a separate outlet 56 for dead fish and optionally, with a separate outlet 59 for living fish.

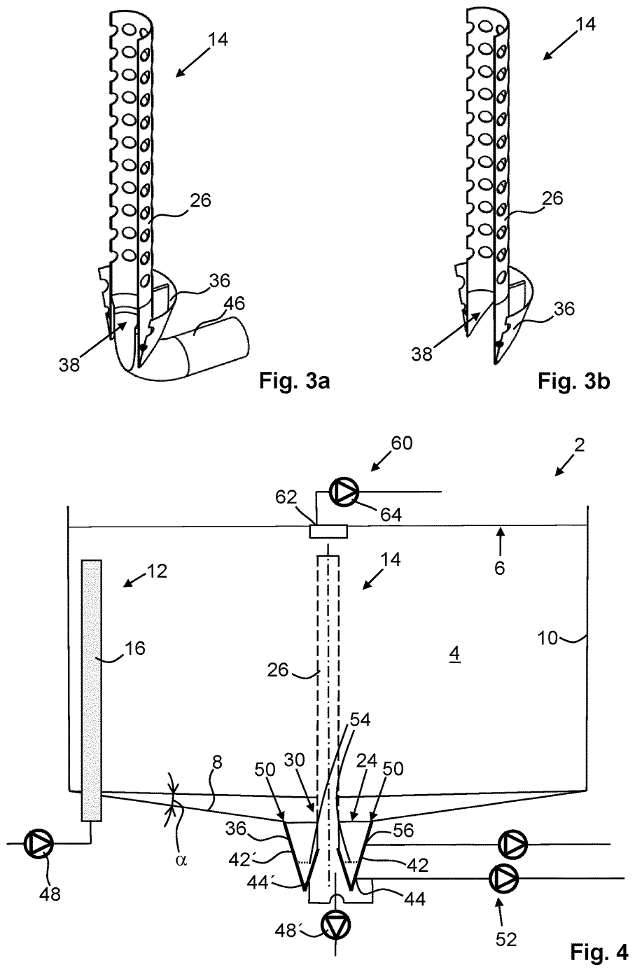

FIGS. 3a and 3b disclose alternative embodiments of a water outlet arrangement 14. The water outlet arrangement 14 may be comprised in embodiments of a fish farming enclosure 2 as discussed herein. Accordingly, in the following reference is also made to FIGS. 1a-2c.

The water outlet arrangement 14 shown in FIG. 3a may be utilised in embodiments of the fish framing enclosure 2 discussed above with reference to FIGS. 1a and 1b. More specifically, in an enclosure 2 for land-based use, wherein the outflowing water from the water outlet arrangement 14 has to be conducted from the enclosure 2 e.g., to a specific destination or recipient, the water outlet arrangement 14 comprises a further conduit portion 46 arranged downstream of the elongated conduit member 26.

However, the water outlet arrangement 14 shown in FIG. 3a also may be utilised in an enclosure 2 for sea-based use i.e., for directing outflowing water to a specific destination from an enclosure 2 used in open water.

The further conduit portion 46 may connect directly to the elongated conduit member 26. In such embodiments, the sludge collecting member 36, in the water passage formed by the through opening 38 of the sludge collecting member 36, is not in direct contact with the water passing out from the enclosure 2.

Alternatively, the further conduit portion 46 may connect to the through opening 38 of the sludge collecting member 36 i.e., to the water passage 38 formed by the through opening 38. In such embodiments, the sludge collecting member 36, in the water passage formed by the through opening 38 of the sludge collecting member 36, is in direct contact with the water passing out from the enclosure 2.

The water outlet arrangement 14 shown in FIG. 3b may be utilised in an enclosure 2 for sea-based use i.e., in an enclosure 2 used in open water.

In these embodiments, the through opening 38 of the sludge collecting member 36, leads directly to the water below the enclosure 2. Accordingly, in such embodiments, the water passage formed by the through opening 38 of the sludge collecting member 36, is in direct contact with the water passing out from the enclosure 2.

FIG. 4 schematically illustrates a cross section through a fish farming enclosure 2 according to embodiments. The enclosure 2 may be an enclosure 2 according to embodiments as discussed above with reference to FIGS. 1a-3b. Accordingly, in the following repetition of features is largely avoided.

Again, the enclosure 2 defines an internal volume 4 for holding water up to a maximum water fill level 6. The enclosure 2 comprises a bottom 8, a side wall arrangement 10, a water inlet arrangement 12, and a water outlet arrangement 14.

Again, the enclosure comprises a sludge collecting member 36 arranged at a second end portion 30 of an elongated conduit member 26 of the outlet arrangement 14. The sludge collecting member 36 comprises at least one trough-shaped portion 42, 42′.

In FIG. 4, one inlet member 16 out of two, three, four, five, or more inlet members 16 of the water inlet arrangement 12 is shown.

One or more water moving devices 48 may form part of the water inlet arrangement 12. In such case, the one or more water moving devices is/are provided for injecting water into the internal volume 4. Additionally, or alternatively, one or more water moving devices 48′ may form part of the water outlet arrangement 14. In such case, the one or more water moving devices 48′ is/are provided for drawing water from the internal volume 4.

Thus, the active flow control system may be provided by the water inlet arrangement 12 and the water outlet arrangement 14.

Mentioned purely as an example, the one or more water moving devices 48, 48′ forming part of the water inlet and/or outlet arrangement 12, 14 may be configured to produce a water moving speed of 0.15-1 m/s in the internal volume 4. Thus, sludge and other matter may be transported along the bottom 8 by the circulating water towards the centre region of the bottom 8. The water moving speed is measured in a tangential direction of the circulating water flow.

During use of the fish farming enclosure 2, fresh water from a fresh water source, such as a sea, lake, river, pond or the like, may be supplied to the one or more water moving devices 48 forming part of the water inlet arrangement 12, or directly to the inlet members 16.

During use of the fish farming enclosure 2, outflow of water via the water outlet arrangement 14 may be a natural outflow caused by the surplus of water injected into the internal volume 4 and gravity, and/or forced outflow caused by the one or more water moving devices 48′ forming part of the water outlet arrangement 14.

According to an alternative embodiment, the one or more water moving devices 48 forming part of the water inlet arrangement 12 may be connected to the water outlet arrangement 14 e.g., via a filter and/or a water cleaning device and/or a water conditioning device, such that a closed water flow circulation system is provided.

The bottom 8 of the enclosure 2 may extend downwards at an angle a within a range of 0-30 degrees to a horizontal plane, such as at an angle a within a range of 0 -20 degrees to a horizontal plane.

According to embodiments, such as in the illustrated embodiments, the fish farming enclosure 2 comprise a distinct transition 50 from the bottom 8 of the enclosure 2 to the at least one trough-shaped portion 42, 42′. In this manner, gravity may contribute to transfer of sludge and other matter from the bottom 8 of the enclosure into the at least one sludge-shaped portion 42, 42′ of the sludge collecting member 36.

Moreover, the circulating flow within the internal volume 4, thus, may not penetrate downwardly into the at least one trough-shaped portion 42, 42′, at least not to any larger extent. Accordingly, the flow within the internal volume 4 cannot disturb settling of the sludge and other matter in the sludge collecting member 36.

The distinct transition 50 from the bottom 8 of the enclosure 2 to the at least one trough-shaped portion 42, 42′ is a transition from the surface of the bottom 8 to a water and/or sludge contacting surface of the sludge collecting member 36. The distinct transition 50 may comprise an abrupt directional change of 20-90 degrees.

The sludge collecting member 36 may be configured for removing sludge therefrom.

Accordingly, the fish farming enclosure 2 may comprise a sludge removal arrangement 52 configured for removing sludge from the sludge collecting member 36, wherein the sludge removal arrangement 52 is connected to the at least one outlet for sludge 44, 44′. In this manner, the sludge collecting member 36 may be continuously, or intermittently, relieved of the sludge collected therein.

The sludge removal arrangement 52 may comprise, connected to the at least one outlet 44, 44′ for sludge, conduits and a suitable sludge transporting device, such as a pump, an airlift pump, an injector, etc.

According to embodiments, such as the illustrated embodiments, the sludge collecting member 36 may comprise at least one sieve 54 arranged at a position between the level 24 of the centre region of the bottom 8 and the at least one outlet 44, 44′ for sludge, wherein the at least one sieve 54 extends over a cross section of the sludge collecting member 36 to prevent matter larger than a sieve opening size to reach the at least one outlet 44, 44′ for sludge. In this manner, larger matter may be prevented by the sieve 54 from blocking the at least one outlet 44, 44′ for sludge. Removal of sludge from the sludge collecting member 36 via the at least one outlet 44, 44′ for sludge may thus, be performed unimpededly.

The cross section of the sludge collecting member 36, over which the at least one sieve 54 extends, may be a cross section in a plane extending in the radial direction R.

According to embodiments, such as the illustrated embodiments, the sludge collecting member 36 may be provided with a separate outlet 56 for dead fish, wherein the separate outlet 56 for dead fish is arranged at a position between the sieve 54 and the level 24 of the centre region of the bottom 8. In this manner, dead fish and other matter larger that the sieve opening size of the sieve 54 may be removed from the sludge collecting member 36.

A suitable transporting member 58 for dead fish, such as an airlift pump or an injector, and conduits may be connected to the outlet 56 for dead fish in order to transport dead fish and other matter from the sludge collecting device 36.

Furthermore, the sludge collecting member 36 may be provided with a separate outlet 59 for living fish, see FIG. 2b.

According to embodiments, such as the illustrated embodiments, the fish farming enclosure 2 may comprise a water surface skimmer arrangement 60 arranged centrally of the side wall arrangement 10, wherein the water surface skimmer arrangement 60 comprises an outlet 62 arranged at a vicinity of the maximum water fill level 6 to receive debris from a water surface within the internal volume 4. In this manner, particles and debris lighter than water and thus, floating on the water surface, may be removed from the water surface during use of the enclosure 2.

Due to the active flow control and the resulting circulating flow of water within the internal volume 4, particles and debris lighter than water are transported towards a centre of the internal volume 4, at the water surface. The water surface skimmer arrangement 60 being arranged centrally of the side wall arrangement 10 is thus, positioned to draw the particles and debris from the water surface.

For instance, a pump 64 or other suitable device for drawing water together with the particles and debris lighter than water from the water surface may be comprised in the water skimmer arrangement 60. The pump 64 or other suitable device is connected to the outlet 62 arranged at the vicinity of the maximum water fill level 6.

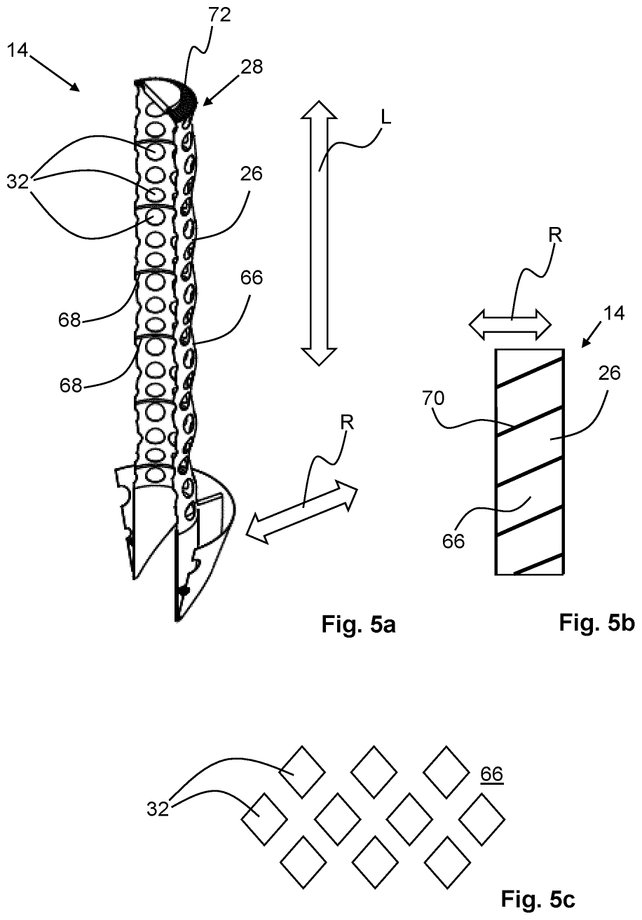

FIGS. 5a-5c schematically illustrate embodiments of a water outlet arrangement 14. The water outlet arrangement 14 may be comprised in embodiments of a fish farming enclosure 2 as discussed herein. Accordingly, in the following reference is also made to FIGS. 1a-4.

According to embodiments, the elongated conduit member 26 may comprise a collapsible wall 66 and a number of ring members 68 or at least one helical member 70, wherein the ring members 68 are, or the at least one helical member 70 is, connected to the collapsible wall 66 such that the collapsible wall 66 is secured in relation to the radial direction R. In this manner, a cost-efficient elongated conduit member 26 may be designed for outflow of water from the internal volume 4 of the enclosure 2.

More specifically, the collapsible wall 66 may be collapsed for ease of transport to, and installation in, a relevant fish farming enclosure 2. Due to the number of ring members 68 or the at least one helical member 70, the collapsible wall 66 is prevented from collapsing during use of the fish farming enclosure 2.

With reference to FIG. 5a, the ring members 68 are connected to the collapsible wall 66 such that the collapsible wall 66 is secured in relation to the radial direction R. For instance, the collapsible wall 66 may be provided with channels or loops through which the ring members 68 extend.

In alternative embodiments, shown in FIG. 5b, the elongated conduit member 26 comprises a collapsible wall 66 and at least one helical member 70. The at least one helical member 70 is connected to the collapsible wall 66 such that the collapsible wall 26 is secured in relation to the radial direction R.

Note that FIG. 5b only shows a portion of the elongated conduit member 26 and that the outlet openings of the elongated conduit member 26 are not shown.

The ring members 68 or the at least one helical member 70 ensure that the elongated conduit member 26 has an open cross section perpendicularly to the longitudinal direction L for the transfer of water through the elongated conduit member 26.

Mentioned as examples the collapsible wall 66 may be made from thin canvas e.g., of the type used in automobile airbags, thin nylon canvas, or thin PVC-canvas. The ring members 68 or the at least one helical member 70 may be made of a material heavier than water such a nylon material.

In the illustrated embodiments, the ring members 68 and the helical member 70 have a substantially circular shape. According to alternative embodiments the ring members 68 and the helical member 70 may have a different shape which expands the collapsible wall 66, such as oval, hexagonal, square, or triangular shape.

According to embodiments, the collapsible wall 66 may have a mesh structure such that outlet openings 32 are formed by mesh openings of the mesh structure. In this manner, the collapsible wall 66 may provide for outflow of water to be comprised in the elongated conduit member 26 forming part of the water outlet arrangement 14.

In FIG. 5a, the mesh structure has been exemplified with round outlet openings 32 in the collapsible wall 66.

In FIG. 5c, a portion of the collapsible wall 66 is shown. In these embodiments, the mesh structure has been exemplified with rhombic outlet openings 32.

In alternative embodiments, the collapsible wall 66 may have differently shaped mesh structures.

According to embodiments, the water outlet arrangement 14 may comprise a buoyancy member 72 arranged at the first end portion 28 of the elongated conduit member 26. In this manner, it may be ensured that the elongated conduit member 26 extends along the longitudinal direction L during use of the fish farming enclosure 2.

The buoyancy member 72 floats upwardly in the water within a fish farming enclosure 2. The buoyancy member 72 may be positioned at the water surface or beneath the water surface during use of the enclosure 2.

It is to be understood that the foregoing is illustrative of various example embodiments and that the invention is defined only by the appended claims. A person skilled in the art will realize that the example embodiments may be modified, and that different features of the example embodiments may be combined to create embodiments other than those described herein, without departing from the scope of the invention, as defined by the appended claims.

1. A fish farming-enclosure enclosure for cultivating living fish, wherein
the fish farming enclosure defines an internal volume for holding water up to a maximum water fill level and comprises a bottom, a side wall arrangement, a water inlet arrangement for admitting water into the internal volume arranged at the side wall arrangement, and a water outlet arrangement for outflow of water from the internal volume arranged centrally of the side wall arrangement, wherein
the water inlet arrangement is configured for admitting water into the internal volume substantially along an entire distance between the maximum water fill level and a level of the bottom in a region of the water inlet arrangement, wherein
the water outlet arrangement comprises an elongated conduit member extending along a longitudinal direction from a first end portion of the elongated conduit member to a second end portion thereof, the first end portion being arranged within a region of the maximum water fill level and the second end portion being arranged at a level of a centre region of the bottom,
wherein
the fish farming enclosure comprises a sludge collecting member arranged at the second end portion of the elongated conduit member, wherein
the sludge collecting member extends along a radial direction, perpendicularly to the longitudinal direction, beyond the radial direction of the elongated conduit member, wherein
the sludge collecting member is provided with a through opening such that a water passage is formed through the sludge collecting member, and wherein
the water passage forms part of the water outlet arrangement.

2. The fish farming enclosure according to claim 1, wherein the elongated conduit member is configured for outflow of water from the internal volume substantially along an entire distance between the first end portion and the level of the centre region of the bottom.

3. The fish farming enclosure according to claim 1, wherein the bottom is impermeable to sludge.

4. The fish farming enclosure according to claim 1, wherein the sludge collecting member comprises at least one trough-shaped portion for receiving sludge therein, and wherein the at least one trough-shaped portion is arranged below the level of the centre region of the bottom.

5. The fish farming enclosure according to claim 4, wherein the at least one trough-shaped portion is arranged circumferentially with respect to the longitudinal direction of the elongated conduit member.

6. The fish farming enclosure according to claim 4, comprising a distinct transition from the bottom of the enclosure to the at least one trough-shaped portion.

7. The fish farming enclosure according to claim 4, wherein the sludge collecting member comprises at least two trough-shaped portions for receiving sludge therein.

8. The fish farming enclosure according to claim 1, wherein the water inlet arrangement is provided with inlet openings, and wherein the inlet openings are arranged to admit water into the internal volume in a direction including a horizontal and tangential component relative to the side wall arrangement.

9. The fish farming enclosure according to claim 1, wherein the sludge collecting member is provided with at least one outlet for sludge.

10. The fish farming enclosure according to claim 9, wherein the sludge collecting member comprises at least one sieve arranged at a position between the level of the centre region of the bottom and the at least one outlet for sludge, and wherein the at least one sieve extends over a cross section of the sludge collecting member to prevent matter larger than a sieve opening size to reach the at least one outlet , for sludge.

11. The fish farming enclosure according to claim 9, comprising a sludge removal arrangement configured for removing sludge from the sludge collecting member, wherein the sludge removal arrangement is connected to the at least one outlet for sludge.

12. The fish farming enclosure according to claim 10, wherein the sludge collecting member is provided with a separate outlet for dead fish, and wherein the separate outlet for dead fish is arranged at a position between the sieve and the level of the centre region of the bottom.

13. The fish farming enclosure according to claim 1, wherein the elongated conduit member comprises a collapsible wall and a number of ring members or at least one helical member, wherein the ring members are, or the at least one helical member is, connected to the collapsible wall such that the collapsible wall is secured in relation to the radial direction.

14. The fish farming enclosure according to claim 13, wherein the collapsible wall has a mesh structure such that outlet openings are formed by mesh openings of the mesh structure.

15. The fish farming enclosure according to claim 13, comprising a buoyancy member arranged at the first end portion of the elongated conduit member.

16. The fish farming enclosure according to claim 1, comprising a water surface skimmer arrangement arranged centrally of the side wall arrangement, wherein the water surface skimmer arrangement comprises an outlet arranged at a vicinity of the maximum water fill level to receive debris from a water surface within the internal volume.

17. The fish farming enclosure according to claim 2, wherein the bottom is impermeable to sludge.

18. The fish farming enclosure according to claim 2, wherein the sludge collecting member comprises at least one trough-shaped portion for receiving sludge therein, and wherein the at least one trough-shaped portion is arranged below the level of the centre region of the bottom.

19. The fish farming enclosure according to claim 3, wherein the sludge collecting member comprises at least one trough-shaped portion for receiving sludge therein, and wherein the at least one trough-shaped portion is arranged below the level of the centre region of the bottom.

20. The fish farming enclosure according to claim 5, comprising a distinct transition from the bottom of the enclosure to the at least one trough-shaped portion.
